(19) United States
(12) Patent Application Publication
(10) Pub. No.: US 2026/0128507 A1
(43) Pub. Date: May 7, 2026

(54) ANTENNAS, ANTENNA ASSEMBLIES, AND EARPHONES

(71) Applicant: SHENZHEN SHOKZ CO., LTD., Shenzhen (CN)

(72) Inventors: Jianhua XIE, Shenzhen (CN); Fen YOU, Shenzhen (CN); Xin QI, Shenzhen (CN)

(73) Assignee: SHENZHEN SHOKZ CO., LTD., Shenzhen (CN)

(21) Appl. No.: 19/434,062

(22) Filed: Dec. 29, 2025

Related U.S. Application Data
(63) Continuation of application No. PCT/CN2023/139559, filed on Dec. 18, 2023.

(51) Int. Cl. H01Q 1/48; H01Q 1/22; H01Q 1/36; H01Q 5/364; H01Q 5/378; H01Q 23/00

(52) U.S. Cl. CPC H01Q 1/48; H01Q 1/2291; H01Q 1/36; H01Q 5/364; H01Q 5/378; H01Q 23/00

(57) ABSTRACT

Embodiments of the present disclosure relates to an antenna, an antenna assembly, and an earphone. The antenna includes: an antenna body; a feeding portion disposed on the antenna body; and at least two grounding portions spaced apart and disposed on the antenna body, wherein the at least two grounding portions are spaced apart from the feeding portion. Through the above way, the present disclosure may improve the problem that existing antennas are susceptible to interference.

### CROSS REFERENCE TO RELATED APPLICATIONS

This application is a continuation of International Patent Application No. PCT/CN2023/139559, filed on Dec. 18, 2023, the entire contents of which are hereby incorporated by reference.

### TECHNICAL FIELD

The present disclosure relates to the field of electronic devices, and in particular, to an antenna, an antenna assembly, and an earphone.

### BACKGROUND

An antenna is an important component in electronic devices with communication functions. For example, Bluetooth functionality also requires an antenna to achieve the transmission of Bluetooth signals and data. Currently, most electronic devices incorporate antennas, such as mobile phones, computers, earphones, tablet computers, smart wearable devices, etc. Antennas often require a large clearance area to reduce interference from other circuit components.

Currently, a compact design is a prevailing trend for electronic devices. This results in reduced antenna clearance areas and increased interference from surrounding circuits, which ultimately leads to low antenna radiation efficiency.

### SUMMARY

The main technical problem solved by the present disclosure is to provide an antenna, an antenna assembly, and an earphone, which can improve the problem that existing antennas are susceptible to interference from surrounding circuits, which leads to low antenna radiation efficiency.

To solve the above technical problem, an embodiment of the present disclosure provides an antenna. The antenna includes an antenna body; a feeding portion connected to the antenna body; and at least two grounding portions spaced apart and connected to the antenna body. The at least two grounding portions are spaced apart from the feeding portion.

Compared with the prior art, the beneficial effect of the present disclosure is as follows: by configuring the antenna to include at least two grounding portions spaced apart and connected to the antenna body, the multi-point grounding achieved through the at least two grounding portions creates a plurality of electric field null points. These electric field null points effectively reduce electrical coupling generated by adjacent circuit components, thereby mitigating interference to the antenna. This design enables effective suppression or shielding of interference from other circuit components, ultimately enhancing the antenna's performance.

In some embodiments, the antenna body forms an operating path between two adjacent grounding portions, the operating path includes a first operating path, and a length of the first operating path matches a first operating wavelength of the antenna.

In some embodiments, the antenna body is arranged in a linear form, and a length of the operating path between the two adjacent grounding portions is set as a path length along the antenna body between the two adjacent grounding portions.

In some embodiments, the antenna body is arranged in a planar form, and the at least two grounding portions are spaced apart on a peripheral edge of the antenna body. A length of the operating path between the two adjacent grounding portions is set as a path length along the peripheral edge of the antenna body between the two adjacent grounding portions.

In some embodiments, the feeding portion and the at least two grounding portions extend from the antenna body and are arranged in a sheet form. The peripheral edge of the antenna body is provided with a notch, and the feeding portion is connected to an edge of the notch. One of the at least two grounding portions is connected to an adjacent edge of the peripheral edge, the adjacent edge being connected to the edge of the notch. A main surface of the feeding portion and a main surface of the grounding portion connected to the adjacent edge face outward on a same side of the antenna body or are parallel to each other.

In some embodiments, the antenna body is configured as an integrated structure, and the length of the first operating path is set to an integer multiple of half of the first operating wavelength of the antenna.

In some embodiments, the antenna body is arranged in a planar form. A count of the at least two grounding portions is two, and the two grounding portions are connected to a peripheral edge of the antenna body. The operating path includes a second operating path. One side edge of the peripheral edge of the antenna body located between the two grounding portions is configured to form the first operating path. Another side edge of the peripheral edge of the antenna body located between the two grounding portions is configured to form the second operating path.

In some embodiments, an absolute value of a difference between the length of the first operating path and a length of the second operating path falls within a range of 0 mm to 5 mm.

In some embodiments, a length of the second operating path is set to match a second operating wavelength of the antenna body different from the first operating wavelength.

In some embodiments, the first operating wavelength includes a wavelength corresponding to 2.4 GHz, and the second operating wavelength includes a wavelength corresponding to 5 GHz.

In some embodiments, the antenna body has an electric field strong point location, and includes a first main body portion and a second main body portion divided by the electric field strong point location. The feeding portion and at least one of the at least two grounding portions are connected to the first main body portion. At least one of the remaining of the at least two grounding portions is connected to the second main body portion.

In some embodiments, the first main body portion and the second main body portion are arranged spaced apart. The first main body portion has a first gap edge, and the second main body portion has a second gap edge. The first gap edge and the second gap edge are opposite to and spaced apart from each other to form a gap, the gap separating the first main body portion from the second main body portion. The first main body portion, the at least one grounding portion connected to the first main body portion, and the feeding portion form a main antenna. The second main body portion and the at least one grounding portion connected to the second main body portion form a parasitic antenna.

In some embodiments, the first main body portion is provided with a first sub-operating path between the first gap edge and the grounding portion connected to the first main body portion, a length of the first sub-operating path being set to an odd multiple of a quarter of the first operating wavelength of the antenna. In some embodiments, the second main body portion is provided with a second sub-operating path between the second gap edge and the grounding portion connected to the second main body portion, a length of the second sub-operating path being set to an odd multiple of the quarter of the first operating wavelength of the antenna.

In some embodiments, a width of the gap is in a range of 0.1 mm to 5 mm.

In some embodiments, the first main body portion and the second main body portion are integrally formed.

On the other hand, one or more embodiments of the present disclosure provide an antenna assembly. The antenna assembly includes a circuit board; and an antenna. The feeding portion and the at least two grounding portions are connected to the circuit board, and the antenna body is spaced apart from the circuit board.

In some embodiments, the antenna assembly further includes at least two connection wires connected to wire connection points on the circuit board. Each of the at least two grounding portions corresponds to one of the wire connection points. For each of the at least two grounding portions, compared with other grounding portions, the grounding portion is located closer to a wire connection point corresponding to the grounding portion.

In some embodiments, the antenna assembly includes a transmission interface configured to couple to an external device. The transmission interface is electrically connected to and spaced apart from the circuit board, and is grounded through the circuit board to form the parasitic antenna.

In some embodiments, a minimum distance between the transmission interface and the antenna body is in a range of 0.5 mm to 5 mm.

In some embodiments, at least one of an inductor, a capacitor, or a resistor is disposed between the transmission interface and the circuit board.

On the other hand, the present disclosure also includes an earphone. The earphone includes an earphone body and the antenna assembly disposed on the earphone body.

### BRIEF DESCRIPTION OF THE DRAWINGS

In order to more clearly illustrate the technical solutions in the embodiments of the present disclosure, the following will briefly introduce the drawings needed for the description of the embodiments. Obviously, the drawings in the following description are only some embodiments of the present disclosure. For those skilled in the art, other drawings may also be obtained based on these drawings without creative effort.

FIG. 1 is a schematic diagram illustrating a front view of an exemplary structure of an antenna assembly according to some embodiments of the present disclosure;

FIG. 2 is a schematic diagram illustrating a top view of an exemplary structure of an antenna assembly according to some embodiments of the present disclosure;

FIG. 3 is a schematic diagram illustrating an exemplary structure of a first operating path and a second operating path shown in FIG. 2;

FIG. 4 is a schematic diagram illustrating another top view of an exemplary structure of an antenna assembly according to some embodiments of the present disclosure;

FIG. 5 is a schematic diagram illustrating an exemplary structure of a first sub-operating path and a second sub-operating path shown in FIG. 4;

FIG. 6 is a schematic diagram illustrating yet another top view of an exemplary structure of an antenna assembly according to some embodiments of the present disclosure;

FIG. 7 is a schematic diagram illustrating an exemplary structure of an earphone according to some embodiments of the present disclosure; and

FIG. 8 is a schematic diagram illustrating a radiation efficiency comparison between an antenna assembly of the present disclosure and a conventional inverted-F antenna (IFA).

### DETAILED DESCRIPTION

The following will describe in detail the embodiments of the technical solutions of the present disclosure with reference to the accompanying drawings. The following embodiments are only used to illustrate the technical solutions of the present disclosure more clearly, and are therefore only examples, and should not be used to limit the protection scope of the present disclosure.

In the description of the embodiments of the present disclosure, technical terms such as “first”, “second”, etc., are only used to distinguish different objects and should not be understood as indicating or implying relative importance or implicitly specifying the quantity, specific order, or primary-secondary relationship of the indicated technical features. In the description of the embodiments of the present disclosure, the meaning of “a plurality” is two or more, unless explicitly and specifically defined otherwise.

In the description of the embodiments of the present disclosure, unless otherwise explicitly specified and defined, technical terms such as “install”, “connect”, “link”, “fix”, “set”, etc., should be understood broadly. For example, it may be a fixed connection, a detachable connection, or an integrated connection; it may be a direct connection or an indirect connection. For those skilled in the art, the specific meanings of the above terms in the embodiments of the present disclosure may be understood based on the specific circumstances.

Through research, the inventors of the present disclosure have discovered that for electronic devices, such as mobile phones, computers, earphones, tablet computers, smart wearable devices, etc., a compact design is often required, leading to a limited internal space, which in turn leads to reduced antenna clearance areas. Consequently, significant interference from nearby circuit components occurs, causing degraded antenna performance characterized by low radiation efficiency.

To solve the above problem, the present disclosure provides the following embodiments, which describe exemplary structures of an antenna.

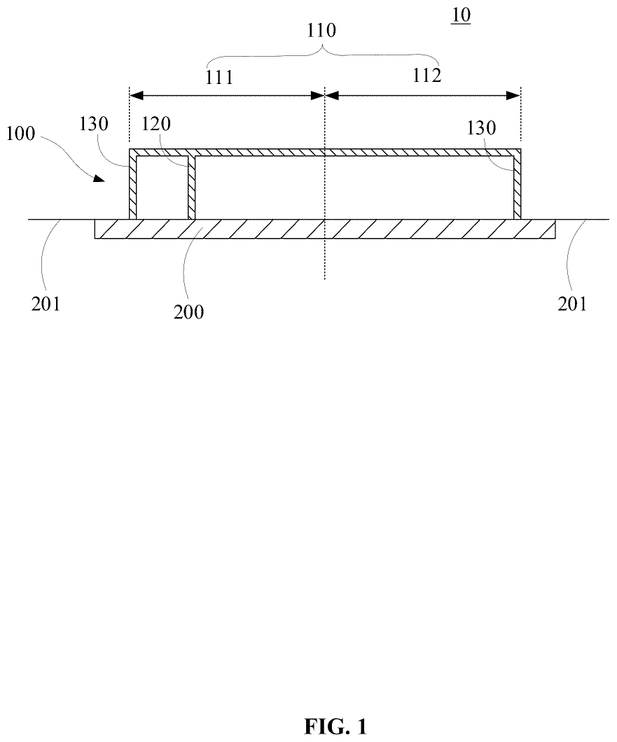

Referring to FIG. 1, an antenna 100 may include an antenna body 110, a feeding portion 120, and at least two grounding portions 130. The feeding portion 120 is connected to the antenna body 110. The at least two grounding portions 130 are spaced apart and connected to the antenna body 110. The at least two grounding portions 130 are all spaced apart from the feeding portion 120. The grounding portions 130 may be configured to connect grounding points of a circuit board 200. Specifically, the antenna body 110 may be connected to the ground of the circuit board 200 through the grounding portions 130. The feeding portion 120 may be configured to connect a feeding point of the circuit board 200. Signals on the circuit board 200 may be transmitted to the antenna body 110 via feeding points on the circuit board 200 and the feeding portion 120.

Generally, mobile terminals (e.g., mobile phones, earphones, etc.) have a compact structure and a small dimension, resulting in a small clearance area for the antenna, which also limits a design dimension corresponding to an operating frequency band of the antenna. Moreover, due to the compact structure, numerous electronic components are often gathered near the antenna. These electronic components, which are close to the antenna, interfere with the radiation of the antenna, resulting in low radiation efficiency and poor performance. The radiation efficiency of the antenna 100 refers to a ratio of a radiation power of the antenna 100 to an input power. The operating frequency band of the antenna 100 refers to a frequency band that meets preset conditions when the antenna 100 operates.

On one hand, the at least two grounding portions 130 enable the antenna 100 to be grounded at least two points, forming at least two electric field null points, which can effectively reduce the electrical coupling generated by adjacent other electronic devices/circuits on the antenna 100, thereby effectively reducing or shielding interference from the adjacent other electronic devices on the antenna 100, and further improving the radiation efficiency of the antenna 100.

On the other hand, since the at least two grounding portions 130 are spaced apart on the antenna body 110 and connected to different positions on the antenna body 110, the antenna 100 has a plurality of current strong points. Thus, the grounding portions 130 at different connection positions may be combined with the antenna body 110, which enables the antenna 100 to present a plurality of antenna modes under certain circumstances. The plurality of antenna modes may be the same or different. When the plurality of antenna modes are the same, the plurality of antenna modes operate at the same operating frequency, which can improve the radiation efficiency of the antenna 100 at that operating frequency. When the plurality of antenna modes are different, the plurality of antenna modes operate at different operating frequencies, which can expand an operating bandwidth of the antenna. For example, by expanding a certain frequency band or exciting radiation of a plurality of different frequency bands, the antenna 100 may meet the requirements of more radiation scenarios.

The antenna 100 may include at least two grounding portions 130, indicating that a count of the grounding portions 130 may be three, four, or more. In some embodiments, the feeding portion 120 may be closer to at least one of the at least two grounding portions 130. On one hand, this arrangement makes it easier to generate different antenna modes; on the other hand, the dimension of the antenna may be as small as possible while meeting a required operating frequency band.

In some embodiments, the antenna body 110 may be provided with an operating path between two adjacent grounding portions 130. The operating path is a physical structural path of the antenna body 100 (e.g., a dimension such as a length of a certain structure). For example, the operating path is a straight or non-straight path between grounding points on the antenna body 100 that are connected to the two grounding portions 130. The physical structural path meets radiation requirements of the operating frequency of the antenna 100. That is, when designing the antenna 100, the physical path needs to be designed considering the radiation requirements of the operating frequency.

In some embodiments, the antenna body 110 is arranged in a linear form. A length of the operating path may be set as a path length along the antenna body 110 between the two adjacent grounding portions 130. The antenna body 110 being arranged in the linear form means that the antenna body 110 is substantially like a body structure of an IFA. For example, the antenna body 110 may be an elongated strip-shaped or rod-shaped structure, and may also be an elongated sheet-shaped structure.

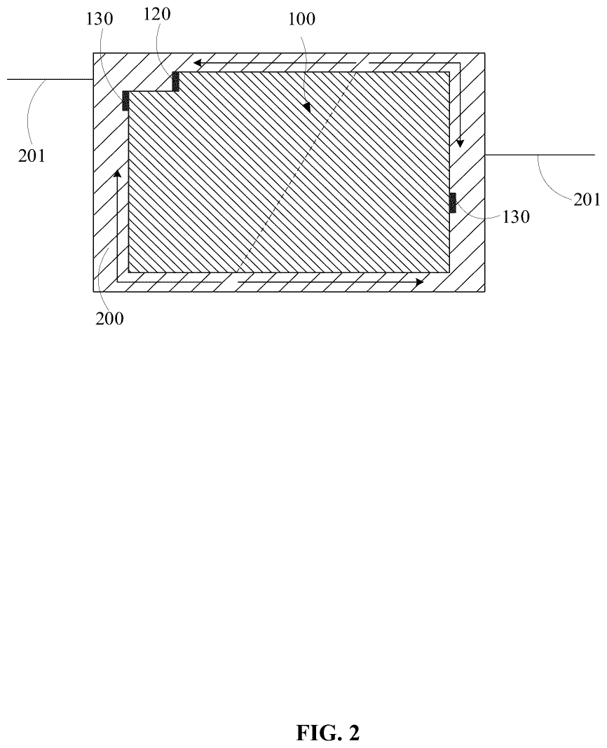

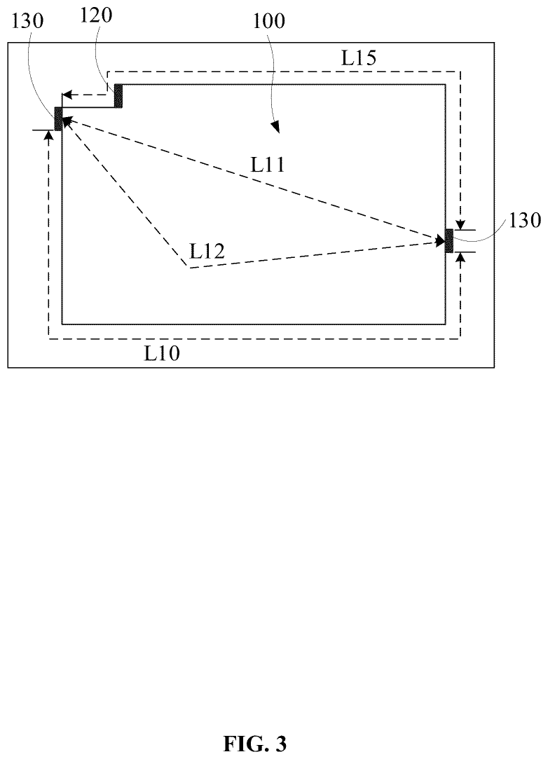

In some embodiments, referring to FIGS. 2 and 3, the antenna body 110 is arranged in a planar form. The antenna body 110 being arranged in a planar form means that the antenna body 110 is substantially like the body structure of a planar inverted-F antenna (PIFA). For example, the antenna body 110 may be a plate-shaped structure. For a planar antenna body 110, a main surface of the antenna body 110 (e.g., a surface with the largest area) may be substantially planar or a non-planar surface with protrusions or depressions. The at least two grounding portions 130 are spaced apart and connected to a peripheral edge of the antenna body 110. When the antenna body is arranged in the planar form, a plurality of operating paths may be provided.

Referring to FIG. 3, in some embodiments, the operating path may be a path L10 along the peripheral edge of the antenna body 110 between two adjacent grounding portions 130. In other embodiments, the operating path may be a path L11 along a spacing direction between two adjacent grounding portions 130, or a path L12 from one grounding portion 130 to another grounding portion 130 via one or more transition points. The one or more transition points may be any one or more points on the antenna body 110. The length of the operating path may be set as a path length along the peripheral edge of the antenna body 110 between the two adjacent grounding portions 130.

In a specific embodiment, the operating path is the path L10 along the peripheral edge of the antenna body 110 between two adjacent grounding portions 130. In this case, the overall dimension of the antenna body 110 may be relatively small.

Through the above settings, whether for a linear antenna 110 or a planar antenna 110, the at least two grounding portions 130 may present the plurality of antenna modes under certain circumstances, thereby expanding the corresponding operating frequency band range or exciting radiation of a plurality of different operating frequency bands. In other embodiments, there may be one operating path between every two adjacent grounding portions 130, so that the at least two grounding portions 130 may enable the antenna 100 to potentially have a plurality of operating paths. In this case, the length of one operating path meets the radiation requirements of the antenna at a certain operating frequency band. If other operating paths exist, the plurality of operating paths may further serve to expand the operating frequency band of the antenna or excite radiation of other different operating frequency bands, thereby achieving multi-band radiation.

The operating path may include a first operating path. A length of the first operating path matches a first operating wavelength of the antenna 100, meaning that under the first operating path whose length matches the first operating wavelength, the antenna body 110 may radiate electromagnetic wave signals with the first operating wavelength through the first operating path. In other words, the antenna 100 has a first operating frequency or a first operating frequency range, and the first operating frequency or the first operating frequency range corresponds to the first operating wavelength. The length of the first operating path is set to match the first operating wavelength of the antenna 100, thereby enabling the antenna 100 to radiate electromagnetic waves outward at the first operating wavelength, thus meeting the corresponding radiation requirements. For example, the first operating wavelength may be a wavelength corresponding to 2.4 GHz or 5 GHz.

Through the above settings, whether for the linear antenna 110 or the planar antenna 110, the at least two grounding portions 130 may be provided with the first operating path, thereby meeting the radiation requirements of the operating frequency band corresponding to the first operating wavelength. On this basis, under certain circumstances, the antenna 100 may also form other operating paths. The first operating path and the other operating paths resonate to produce the plurality of antenna modes, expanding the frequency band corresponding to the first operating wavelength or enabling the radiation requirements of the plurality of different operating frequency bands to be met.

For example, the operating path may also include a second operating path. In some embodiments, the second operating path may expand the operating frequency band corresponding to the first operating wavelength or enhance the radiation efficiency of the operating frequency at the first operating wavelength. For example, an absolute value of a difference between the length of the first operating path and a length of the second operating path falls within a range of 0 mm to 5 mm. With this arrangement, the length of the second operating path is as close as possible to the length of the first operating path, which can effectively expand the operating frequency band range corresponding to the first operating wavelength or further enhance the radiation of the operating frequency band corresponding to the first operating wavelength, thereby effectively improving the radiation efficiency.

In some embodiments, the absolute value of the above difference falls within a range of 0 mm to 3 mm, which can further make the length of second operating path as close as possible to that of the first operating path, thereby expanding the operating frequency band range corresponding to the first operating wavelength. In some embodiments, the absolute value of the above difference may be within a range of 0 mm to 2 mm or a range of 0 mm to 1 mm.

In other embodiments, the second operating path may meet the radiation requirements of an operating frequency band corresponding to a second operating wavelength different from the first operating wavelength. That is, the antenna 100 may radiate two different wavelengths. The first operating path and the second operating path can meet the radiation requirements of the operating frequency bands corresponding to different operating wavelengths. Specifically, the length of the second operating path is set to match the second operating wavelength of the antenna body 110, which is different from the first operating wavelength. Thus, the length of the second operating path may meet the radiation requirements of the operating frequency band corresponding to the second operating wavelength, enabling the antenna 100 to meet the radiation requirements of both the first operating wavelength and the second operating wavelength and meet the radiation requirements for various wireless frequency bands, thereby achieving a multi-mode connection of the antenna 100.

Whether the antenna body 110 is linear, planar, or other shapes, it may be structurally configured as an integrated structure or a split structure.

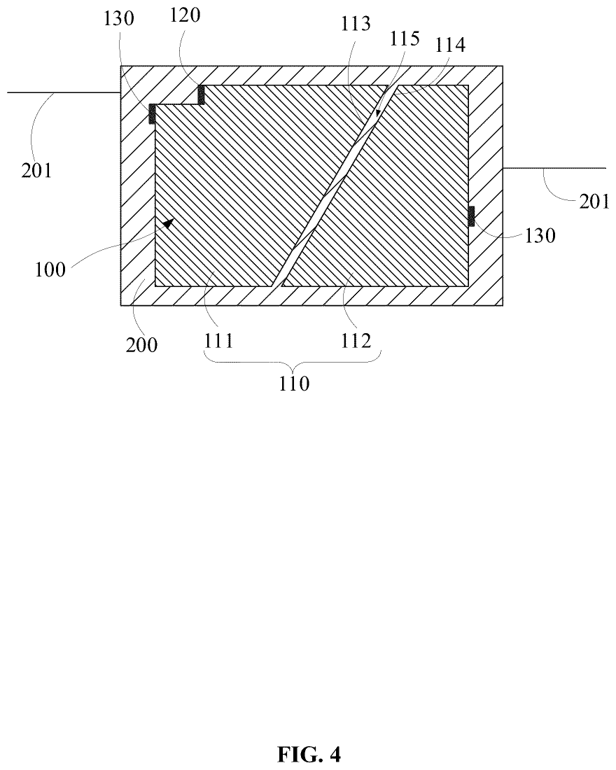

Referring to FIGS. 2 and 4, in some embodiments, the antenna body 110 may have an electric field strong point location. The antenna body 100 may include a first main body portion 111 and a second main body portion 112 divided by the electric field strong point location. The feeding portion 120 and the at least one grounding portion 130 are connected to the first main body portion 111. At least another grounding portion 130 is connected to the second main body portion 112. Taking two grounding portions 130 as an example, the electric field strong point location is located between the two grounding portions 130. The feeding portion 120 and one of the two grounding portions 130 are connected to the first main body portion 111, and the other one of the two grounding portions 130 is connected to the second main body portion 112. In some embodiments, the first main body portion 111 and the second main body portion 112 may be configured as an integrated structure. For example, the first main body portion 111 and the second main body portion 112 are integrally formed. In some embodiments, the first main body portion 111 and the second main body portion 112 may be configured as a split structure. For example, the first main body portion 111 and the second main body portion 112 are arranged spaced apart from each other.

For an antenna with the integrated structure, the electric field strong point location may substantially refer to the position shown by the dashed line in FIG. 2. The current direction may include the direction from the electric field strong point location along the peripheral edge of the planar antenna towards the grounding portion as indicated by the arrow in the FIG. 2, or may include the direction from any point of the electric field strong point location directly towards the grounding portion.

The following describes the integrated structure and the split structure separately.
(1) The antenna body 110 may be configured as the integrated structure (referring to FIGS. 2 and 3).

As described above, the at least two grounding portions 130 may reduce the electrical coupling from adjacent other circuit devices/circuits and reduce interference from the other circuit devices on the antenna 100. In terms of the operating mode of the antenna 100, the at least two grounding portions 130 are spaced apart and connected to the antenna body 110, so that the antenna 100 may excite a slot antenna mode or a mode similar to the slot antenna. For example, the antenna 100 is coupled to the circuit board 200. The feeding portion 120 is electrically connected to the circuit board 200, and an excitation signal is input from the circuit board 200 to the feeding portion. The at least two grounding portions 130 are also electrically connected to the circuit board 200 and grounded through the circuit board 200. Since there is a gap between the antenna body 110 and the circuit board 200, the antenna 100 may further excite the slot antenna mode or a mode similar to the slot antenna.

A dimension of the slot antenna is affected by positions or a distance of the at least two grounding portions 130. Therefore, an operating frequency band of the slot antenna may be controlled by controlling a relative position or a relative distance of the at least two grounding portions 130. In some embodiments, the length of the first operating path between two adjacent grounding portions 130 matches the operating wavelength of the antenna body 110. By setting the relative position between two adjacent grounding portions 130, the corresponding first operating path may be adjusted to match the operating frequency band or the operating frequency band range corresponding to the first operating wavelength. For example, the length of the first operating path is set to half of the first operating wavelength of the antenna 100.

In some embodiments, for the linear antenna 100, the length of the first operating path is set as a path length along the antenna body 110 between the two adjacent grounding portions 130. In other words, the path length is an extended length of the antenna body 110 between connection points of the two corresponding grounding portions 130 and the antenna body 110. Taking the antenna 100 including two grounding portions 130 as an example, the length of the first operating path is set as the path length along the antenna body between the two corresponding grounding portions 130.

Specifically, the length of the first operating path is set to half of the first operating wavelength of the antenna 100. On the basis of exciting the slot antenna mode, by setting the length of the first operating path to half of the first operating wavelength, a half-wavelength slot antenna mode may be provided, which can meet the radiation requirements of wireless communications such as Bluetooth. In the design stage, the operating frequency band of the slot antenna is controlled by at least adjusting the distance between two adjacent grounding portions 130, which can effectively improve the design freedom of the antenna 100.

As mentioned above, the count of the grounding portions 130 may be at least two. Taking the count of the grounding portions 130 as three as an example, the three grounding portions 130 are arranged spaced apart along the antenna body 110. The operating path between two adjacent grounding portions 130 may be the first operating path, and the length of the first operating path may be half of the first operating wavelength of the antenna 100. The operating path between the other two adjacent grounding portions 130 may be the second operating path, and the length of the second operating path may be equal to half of the first operating wavelength of the antenna 100 or not. If the length of the second operating path between the other two adjacent grounding portions 130 is equal to half of the operating wavelength of the antenna 100, the antenna efficiency at the first operating wavelength may be further enhanced. If the length of the second operating path between the other two adjacent grounding portions 130 is not equal to half of the first operating wavelength of the antenna 100, the operating frequency band may be expanded.

From a perspective of the slot antenna, three or more grounding portions 130 may excite at least two slot antenna modes based on the same linear antenna body 110. If the at least two slot antenna modes may excite radiation in the same operating frequency band, or if the operating frequency bands excited by the at least two slot antenna modes are not completely the same or completely different, the operating frequency band of the antenna 100 can be effectively expanded, or radiation in different operating frequency bands can be achieved. Moreover, the at least two grounding portions 130 enable the antenna 100 to be grounded at a plurality of points (current null points), which can weaken the electrical coupling between the surrounding circuits and the antenna 100, thereby reducing interference from adjacent other circuit components on the antenna, effectively reducing or shielding interference, and improving the performance of the antenna.

In other embodiments, for a planar antenna body 110, the at least two grounding portions 130 may be connected to the peripheral edge of the antenna body 110. Specifically, a portion of the peripheral edge of the antenna body 110 between two adjacent grounding portions 130 and the circuit board 200 (similar to the ground) may constitute the slot antenna mode or a mode similar to the slot antenna. Thus, the antenna 100 may form at least two slot antenna modes. In addition, since the antenna body 100 is arranged in a planar form, a planar antenna mode may also be simultaneously excited, enabling the antenna 100 to function as a composite antenna, which can effectively expand the operating frequency band of the antenna 100 and improve the radiation efficiency of the antenna 100.

For the slot antenna, there may be a plurality of operating paths between the at least two grounding portions 130. Specifically, one operating path may be provided between every two adjacent grounding portions 130. In some embodiments, the length of the operating path is set as the path length along the peripheral edge of the antenna body 110 between the two corresponding grounding portions 130. In other words, the length of the first operating path is a length of a portion of the peripheral edge of the antenna body 110 between the connection points of the two corresponding grounding portions 130.

Specifically, the portion of the peripheral edge of the antenna body 110 between two adjacent grounding portions 130 and the circuit board 200 (similar to the ground) may excite a mode similar to slot antenna, and the frequency band of the mode similar to slot antenna matches the operating wavelength of the antenna 100. The planar antenna body 110 may excite a plurality of slot antenna modes, and different slot antennas may meet the radiation requirements of the same or different operating wavelengths based on the path length, thus expanding the operating frequency band range, achieving the radiation requirements for the plurality of different operating frequency bands, or improving work radiation efficiency.

Referring to FIG. 3, taking the antenna 100 including two grounding portions 130 as an example, the length of the operating path is set as the path length along the peripheral edge of the antenna body 110 between the two corresponding grounding portions 130.

Along the peripheral edge of the planar antenna body 110, there may be two operating paths between the two grounding portions 130, which may excite two slot antenna modes. One side edge of the peripheral edge of the antenna body 110 located between the two grounding portions 130 is configured to form the first operating path L10, and the other side edge of the peripheral edge of the antenna body 110 located between the two grounding portions 130 is configured to form the second operating path L15.

That is, the two grounding portions 130 are connected to the peripheral edge of the antenna body 110. One side edge of the peripheral edge of the antenna body 110 located between the two grounding portions 130 is configured to form the first operating path, and the other side edge of the peripheral edge of the antenna body 110 located between the two grounding portions 130 is configured to form the second operating path.

Taking the antenna 100 including three or more grounding portions 130 as an example, the length of the operating path is set as a path length along the peripheral edge of the antenna body 110 between every two adjacent grounding portions 130. The antenna 100 may excite at least three antenna modes through the at least three grounding portions 130.

A partial edge of the peripheral edge of the antenna body 110 located between two adjacent grounding portions 130 is configured to form the first operating path. A partial edge of the peripheral edge of the antenna body 110 located between another two adjacent grounding portions 130 is configured to form the second operating path. Similarly, a partial edge of the peripheral edge of the antenna body 110 located between yet another two adjacent grounding portions 130 may also form an operating path. If the count of the grounding portions 130 is three, in this case, along the peripheral edge of the antenna 100, every two adjacent grounding portions 130 may form a slot antenna with the circuit board 200. Therefore, at least three slot antennas may be formed among the three grounding portions 130. The length of the operating path (the first operating path) of one of the at least three slot antennas only needs to match the operating wavelength of the antenna 100.

Therefore, the length of the first operating path only needs to match the first operating wavelength of the antenna 100 to meet the radiation requirements of the operating frequency band corresponding to the first operating wavelength. The length of the second operating path may match the first operating wavelength of the antenna 100, thereby further enhancing the radiation efficiency at the first operating wavelength. Alternatively, the length of the second operating path may not match the first operating wavelength of the antenna 100, thereby expanding the operating frequency band corresponding to the first operating wavelength or exciting radiation in different operating frequency bands.

In some embodiments, the grounding portions 130 may not be connected to the peripheral edge of the antenna body 110 but may be connected within a main surface of the antenna body 110.

In some embodiments, the second operating path may expand the operating frequency band corresponding to the first operating wavelength or enhance the radiation efficiency of the operating frequency at the first operating wavelength. For example, the absolute value of the difference between the length of the first operating path and the length of the second operating path falls within a range of 0 mm to 5 mm. With the arrangement, the length of the second operating path is as close as possible to the length of the first operating path, which can effectively expand the operating frequency band range corresponding to the first operating wavelength or further enhance the radiation of the operating frequency band corresponding to the first operating wavelength, effectively improving the radiation efficiency.

In some embodiments, the absolute value of the above difference falls within a range of 0 mm to 3 mm, which may further make the range of the second operating path as close as possible to that of the first operating path, thereby expanding the operating frequency band range corresponding to the first operating wavelength. In some embodiments, the absolute value of the above difference may be within a range of 0 mm to 2 mm or a range of 0 mm to 1 mm.

During design, appropriately adjusting the relative position of the two grounding portions 130 (or adding new grounding portions 130) may adjust the resonant frequencies of the two slot antennas to near the operating frequency band corresponding to the first operating wavelength (e.g., 2.4 GHz). Thus, compared to a conventional single-mode antenna, the operating frequency band range of the antenna 100 can be effectively expanded.

In other embodiments, the second operating path may meet the radiation requirements of the frequency band corresponding to the second operating wavelength different from the first operating wavelength. That is, the antenna 100 may radiate two different wavelengths. The first operating path and the second operating path may achieve the radiation requirements of the frequency bands corresponding to different operating wavelengths. Specifically, the length of the second operating path is set to match the second operating wavelength of the antenna body 110, which is different from the first operating wavelength. Thus, the length of the second operating path may meet the radiation requirements of the operating frequency band corresponding to the second operating wavelength, enabling the antenna 100 to achieve the radiation requirements of both the first operating wavelength and the second operating wavelength and meet the radiation requirements for various wireless frequency band connections, and thus achieve multi-mode connection of the antenna 100.

For example, the first operating wavelength includes a wavelength corresponding to 2.4 GHz, which meets the radiation requirements of technologies such as Bluetooth. The second operating wavelength includes a wavelength corresponding to 5 GHz, which meets the radiation requirements of technologies such as Wi-Fi. With the arrangement, the antenna 100 may meet the radiation requirements of both 2.4 GHz and 5 GHz, achieving dual-mode or even multi-mode radiation.

From the perspective of the slot antenna, at least two grounding portions 130 may excite at least two slot antenna modes based on the same planar antenna body 110. If the at least two slot antenna modes may excite radiation in the same operating frequency band, the radiation efficiency of the antenna 100 at the operating frequency can be improved. If the operating frequency bands excited by the at least two slot antenna modes are not completely the same or completely different, the operating frequency band of the antenna 100 can be effectively expanded or radiation in different operating frequency bands can be achieved. Moreover, the at least two grounding portions 130 enable the antenna 100 to be grounded at the plurality of points (current null points), which can weaken the electrical coupling between the surrounding circuits and the antenna 100, thereby reducing interference from adjacent other circuit components on the antenna, effectively reducing or shielding interference, and improving the performance of the antenna.

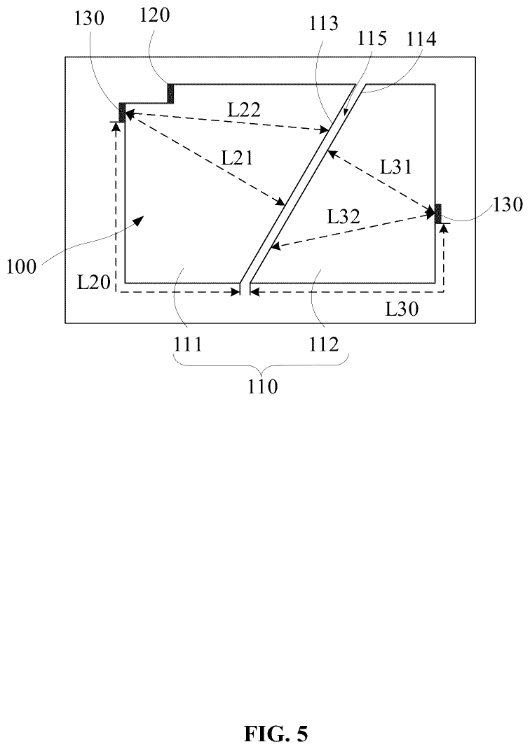

In addition, as shown in FIG. 2, the first main body portion 111 and the second main body portion 112 are integrally formed or connected to form the integrated structure (such as by welding). The first main body portion 111 and the second main body portion 112 may be two portions of the antenna body 110. The first main body portion 111 and the second main body portion 112 are only electrically divided by the electric field strong point location without actual physical segmentation.
(2) The antenna body 110 may be configured as the split structure (referring to FIGS. 4 and 5).

The first main body portion 111 and the second main body portion 112 may be arranged spaced apart from each other. In this case, the antenna body 110 is divided into two independent portions. The first main body portion 111 and the second main body portion 112 are arranged spaced apart and may couple through displacement current.

Taking the antenna 100 including two grounding portions 130 as an example, the electric field strong point location of the antenna body 110 is located between the two grounding portions 130. The feeding portion 120 and one of the two grounding portions 130 are connected to the first main body portion 111, causing the first main body portion 111, the feeding portion 120, and the corresponding grounding portion 130 to form a main antenna. The other one of the two grounding portions 130 is connected to the second main body portion 112, causing the second main body portion 112 and the corresponding grounding portion 130 to form a parasitic antenna.

For the linear antenna body 110, the main antenna may be regarded as the IFA. As mentioned above, the antenna body 110 is arranged in a linear form, which may reference the body structure of the IFA.

For the planar antenna body 110, the main antenna 100 may be regarded as the PIFA. Similarly, as mentioned above, the antenna body 110 is arranged in a planar form, which may reference the body structure of the PIFA.

The IFA or the PIFA usually has grounding portions 130 and the feeding portion 120. The operating frequency band of the IFA or the PIFA is generally affected by factors such as a positional relationship between the grounding portions 130 and the feeding portion 120, a positional relationship between the grounding portions 130 and the electric field strong point location, etc.

In other words, the antenna 100 of the embodiment shown in FIG. 4 includes a first antenna and a second antenna arranged spaced apart. The first antenna is the main antenna, including the first main body portion 111, and the feeding portion 120 and the grounding portion 130 connected to the first main body portion 111. The second antenna is the parasitic antenna, including the second main body portion 112 and the grounding portion 130 connected to the second main body portion 112. The first main body portion 111 has a first gap edge 113. The second main body portion 112 has a second gap edge 114. The first gap edge 113 and the second gap edge 114 are opposite to and spaced apart from each other to form a gap 115. An edge region where the first gap edge 113 and the second gap edge 114 are located may be the electric field strong point location of the antenna 100. The gap 115 separates the first main body portion 111 from the second main body portion 112. The first main body portion 111, and the grounding portion 130 and the feeding portion 120 that are connected to the first main body portion 111 form the main antenna. The second main body portion 112 and the grounding portion 130 connected to the second main body portion 112 form the parasitic antenna. The second main body portion 112 may be considered as a parasitic element parasitized by the first main body portion 111 through current coupling.

Referring to FIG. 5, for the first main body portion 111, the grounding portion 130 (i.e., the grounding portion 130 connected to the first main body portion 111) and the feeding portion 120 may be spaced apart and connected to the edge position of the first main body portion 111. In some embodiments, the grounding portion 130 and the feeding portion 120 may be connected within the first main body portion 111. For example, the grounding portion 130 and the feeding portion 120 may be arranged opposite to the first gap edge 113. A corresponding first sub-operating path is provided between the grounding portion 130 and the first gap edge 113. The first sub-operating path may be a path L20 along the peripheral edge of the first main body portion 111 from the grounding portion 130 to the first gap edge 113, or a path (e.g., L21 and L22) from the grounding portion 130 to any point on the first gap edge 113.

In some embodiments, a length of the first sub-operating path is set to an odd multiple (e.g., one times and three times) of a quarter of the first operating wavelength of the antenna 100, such as a quarter, three-quarters, five-quarters, etc. The length of the first sub-operating path may be a path length along the peripheral edge of the first main body portion 111 from the grounding portion 130 to the first gap edge 113. The length of the first sub-operating path may also be a distance between a connection point of the grounding portion 130 and the first main body portion 111 and any point on the first gap edge 113.

In other words, using the IFA or the PIFA as the main antenna, during design, the structure or dimension of the main antenna may be set according to the requirements of the operating frequency band corresponding to the first operating wavelength of the antenna 100. For example, the length of the first sub-operating path may be set to an odd multiple of a quarter of the first operating wavelength, which may meet the radiation requirements of technologies such as 2.4 GHz Bluetooth.

In addition, the width of the gap 115 may be in a range of 0.1 mm to 5 mm. Setting such a gap distance can effectively cause the main antenna to parasitize the parasitic antenna and enhance the coupling current from the main antenna to the parasitic antenna, thereby improving the radiation efficiency of the parasitic antenna and further expanding the operating bandwidth of the antenna 100. In some embodiments, the gap distance may be in a range of 0.2 mm to 0.3 mm, or a range of 0.5 mm to 3 mm, or a range of 1 mm to 2 mm. This configuration can avoid contact between the first main body portion 111 and the second main body portion 112 to ensure the formation of the parasitic antenna. On the other hand, it can also make the coupling current from the main antenna to the parasitic antenna larger, thereby improving the radiation efficiency of the parasitic antenna.

Referring to FIG. 5, for the second main body portion 112, a corresponding second sub-operating path is provided between the corresponding grounding portion 130 (e.g., the grounding portion connected to the second main body portion 112) and the second gap edge 114. The second sub-operating path may be a path L30 along the peripheral edge of the second main body portion 112 from the grounding portion 130 to the second gap edge 114 or a path (e.g., L31 or L32) from the grounding portion 130 to any point on the second gap edge 114.

A length of the second sub-operating path is set to an odd multiple (e.g., one times and three times) of a quarter of the first operating wavelength of the antenna body 110, such as a quarter, three-quarters, five-quarters, etc. The length of the second sub-operating path may be the path length along the peripheral edge of the second main body portion 112 from the grounding portion 130 to the second gap edge 114. The length of the second operating path may also be a distance between the connection point of the grounding portion 130 and the second main body portion 112 and any point on the second gap edge 114.

By setting the length of the second sub-operating path to an odd multiple (e.g., one times and three times) of a quarter of the first operating wavelength of the antenna 100, the parasitic antenna may also radiate electromagnetic waves with the first operating wavelength, thereby enhancing the radiation of the first operating wavelength together with the main antenna and improving the radiation efficiency of the antenna 100. The length of the second sub-operating path may also be slightly larger or smaller than an odd multiple (e.g., one times and three times) of a quarter of the first operating wavelength to resonate near the operating frequency band corresponding to the first operating wavelength, thereby enhancing the frequency band range of the first operating wavelength.

The above has described that the antenna body 110 may be configured as the integrated structure or the split structure. For an antenna body 110 arranged in a planar form, the peripheral edge of the antenna body 110 is provided with a notch (as shown in FIGS. 2, 3, 4, and 5). The feeding portion 120 and the grounding portions 130 extend from the antenna body 110 and are arranged in a sheet form. The feeding portion 120 is connected to an edge forming the notch in the peripheral edge of the antenna body 110. One of the grounding portions 130 is connected to an adjacent edge in the peripheral edge of the antenna body 110 which is connected to the edge forming the notch.

In some embodiments, a main surface of the feeding portion 120 and a main surface of the grounding portion 130 connected to the adjacent edge face toward the same side of the antenna body or are parallel to each other.

The main surface of the feeding portion 120 refers to a surface of the feeding portion 120 with the largest area. The main surface of the grounding portions 130 refers to a surface of the grounding portion 130 with the largest area. On this basis, the main surface of the feeding portion 120 and the main surface of the grounding portion 130 may be surfaces of the feeding portion 120 and the grounding portion 130 facing the outside of the antenna body 110.

By setting the main surface of the feeding portion 120 and the main surface of the corresponding grounding portion 130 to face toward the same side of the antenna body or to be parallel to each other, the feeding portion 120 and the corresponding grounding portion 130 may be formed by bending in the same direction. for example, by stamping in the same direction, thus improving manufacturing efficiency. Moreover, due to the presence of the notch, a portion of the feeding portion 120 may be formed by stamping a part that originally existed in the notch, thereby saving the material for the entire antenna 100.

According to the above antenna embodiments, the present disclosure also provides an antenna assembly. The following embodiments describe exemplary structures of an antenna assembly 10.

The antenna assembly 10 may include: the circuit board 200 and the aforementioned antenna 100. The feeding portion 120 and the at least two grounding portions 130 of the antenna 100 are connected to the circuit board 200. The antenna body 100 is spaced apart from the circuit board 200.

Usually, when the antenna 100 is assembled onto the circuit board 200 for use, the antenna 100 is highly susceptible to interference from electrical coupling between various electronic components on the circuit board 200 and the antenna 100. In some embodiments, the circuit board 200 is provided with at least two connection wires 201. The connection wires 201 are connected to wire connection points on the circuit board 200. Each grounding portion 130 corresponds to one wire connection point. Among the at least two connection wires 201, each grounding portion 130 is closer to its corresponding wire connection point than other grounding portions. Therefore, by providing the at least two grounding portions 130, at least two electric field null points are formed. The presence of the at least two electric field null points can further reduce the interference of electrical coupling generated around the antenna 100, thereby improving the performance of the antenna 100.

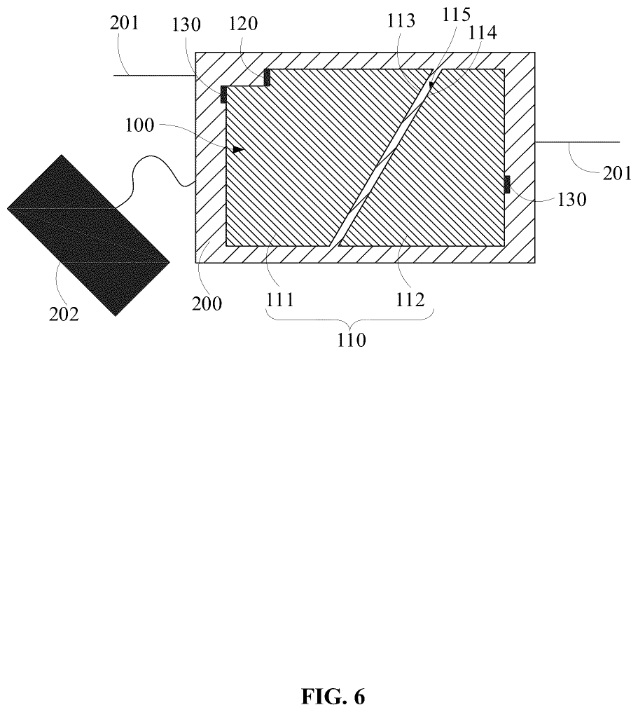

As mentioned above, the parasitic antenna is an antenna 100 that is grounded and includes at least one parasitic element (i.e., an element without the feeding portion 120 or a feeding point). As shown in FIG. 6, in some embodiments, the antenna assembly 10 may further include a transmission interface 202 for coupling to an external device. The transmission interface 202 is electrically connected to and spaced apart from the circuit board 200, and is grounded through the circuit board 200, so that the transmission interface 202 may also serve as the parasitic antenna. Therefore, the transmission interface 202, as the parasitic antenna, may further improve the antenna efficiency of the antenna assembly 10 and expand the operating frequency band. Specifically, the transmission interface 202 may be a Universal Serial Bus (USB) interface or a charging probe interface. The USB interface may be a Type-C interface, a Type-A interface, a Type-B interface, or a microUSB interface.

In some embodiments, a minimum distance between the transmission interface 202 and the antenna body 110 is in a range of 0.5 mm to 5 mm.

In some embodiments, at least one of an inductor, a capacitor, or a resistor is disposed between the transmission interface 202 and the circuit board 200. In this case, the operating frequency band of the parasitic antenna may be controlled by adjusting the parameters of the inductor, the capacitor, and the resistor.

In some embodiments, the antenna assembly 10 may further include a bracket (not shown in figures). The bracket may be disposed between the circuit board 200 and the antenna body 110 to support the antenna body 110, thereby ensuring the structural stability and reliability of the antenna body 110. In some embodiments, the bracket may include a plurality of insulating support posts, and the plurality of insulating support posts may support between the circuit board 200 and the antenna body 110. In other embodiments, the bracket may include a support plate and a plurality of support posts. The support plate supports the antenna body 110, and the plurality of support posts support between the support plate and the circuit board 200.

According to the descriptions of the above antenna assembly and antenna, the present disclosure also provides an earphone. The following embodiment of the present disclosure describes an exemplary structure of an earphone 1.

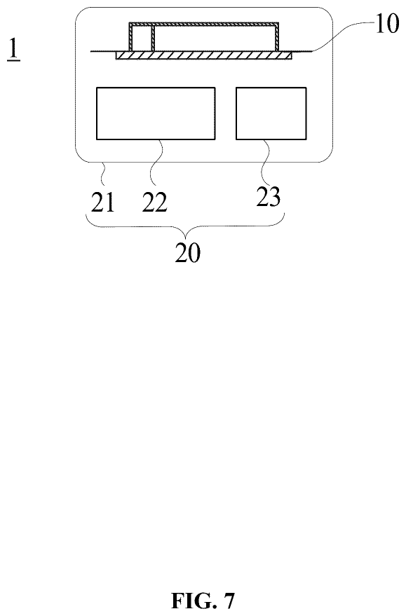

Referring to FIG. 7, the earphone 1 may include an earphone body 20 and the antenna assembly 10 disposed on the earphone body 20. The earphone body 20 may include a housing assembly 21, a speaker 22, and/or a battery 23. The speaker 22, the antenna assembly 10, and the battery 23 may be disposed within the housing assembly 21. The housing assembly 21 may be an earphone housing. The battery 23 may supply power to the speaker 22 and the antenna assembly 10. The antenna assembly 10 may also communicate with the external device (such as an earphone case, a mobile phone, or a computer).

For example, a first operating wavelength of the earphone 1 is 2.4 GHz. For the above-mentioned antenna body 110 configured as an integrated structure, the length of the first operating path may be set to around an integer multiple (e.g., one times and two times) of half of the first operating wavelength. For the antenna body 110 configured as a split structure, the length of the first sub-operating path of the IFA or the PIFA may be set to around an odd multiple (e.g., one times and three times) of a quarter of the first operating wavelength. The second sub-operating path of the parasitic antenna may be configured as needed. For example, the length of the second sub-operating path may be configured to around an odd multiple (e.g., one times and three times) of a quarter of the first operating wavelength. In this case, the operating frequency band of the antenna 100 may be around 2.4 GHz. The antenna 100 may excite a plurality of antenna modes, which may further improve the working efficiency of the antenna 100. In some embodiments, the length of the second sub-operating path may be set to a quarter of the second operating wavelength or an odd multiple of a quarter of the second operating wavelength.

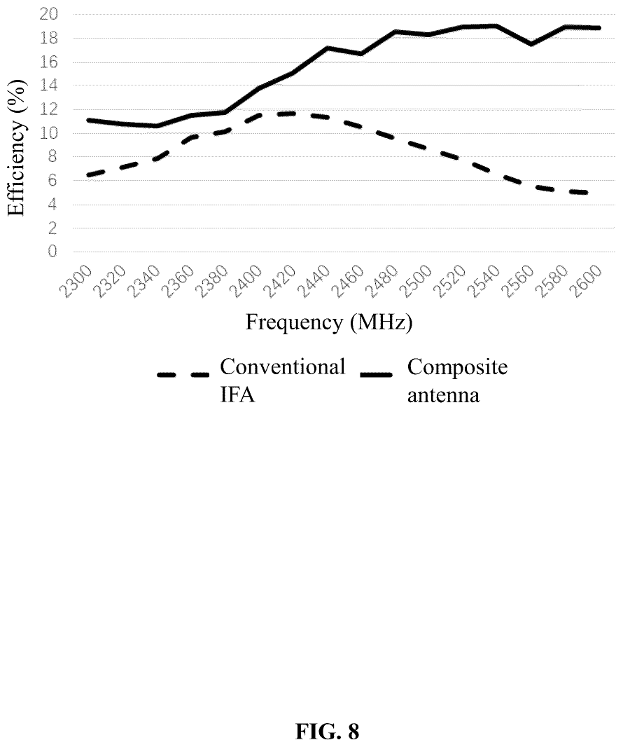

Referring to FIG. 8, when testing with a conventional IFA, the antenna efficiency thereof is relatively low. Assuming that the antenna assembly 10 may communicate stably when the antenna efficiency exceeds 10%, the conventional IFA may communicate stably in the frequency band between 2.38 GHz and 2.48 GHz. However, due to a lack of bandwidth margin, the yield rate in industrial production is low. In contrast, the antenna 100 involved in the present disclosure can reduce the interference of electrical coupling between the surrounding circuits and the antenna 100, making communication more stable. Moreover, the operating frequency band has a larger bandwidth margin, making it more resistant to material and production tolerances, resulting in a higher yield rate in industrial production.

In summary, by providing at least two grounding portions 130 on the antenna body 110 and the at least two grounding portions 130 being located on the same antenna body 110, the at least two grounding portions 130 may form a plurality of grounding points, thereby reducing interference from adjacent other circuit components on the antenna, effectively reducing or shielding interference, and improving the performance of the antenna. Moreover, different grounding portions 130 may form different antennas based on the same antenna body 110, enabling the antenna 100 to function as a composite antenna. In the composite antenna mode, compared to a conventional single antenna mode, the operating frequency band of the antenna can be effectively expanded, or a plurality of different operating frequency bands can be achieved, thereby improving antenna efficiency.

The above is only the implementation of the present disclosure and should not be configured to limit the patent scope of the present disclosure. Any equivalent structure or equivalent process transformation made using the contents of the specification and drawings of the present disclosure, or directly or indirectly applied in other related technical fields, shall be similarly included in the protection scope of the present disclosure.

1-15. (canceled)

16. An antenna assembly, comprising:
a circuit board; and
an antenna, wherein:
the antenna includes an antenna body, a feeding portion connected to the antenna body, and at least two grounding portions spaced apart and connected to the antenna body, the at least two grounding portions are spaced apart from the feeding portion, the feeding portion and the at least two grounding portions are connected to the circuit board, and the antenna body is spaced apart from the circuit board.

17. The antenna assembly of claim 16, wherein:
the antenna assembly further comprises at least two connection wires connected to wire connection points on the circuit board;
each of the at least two grounding portions corresponds to one of the wire connection points; and
for each of the at least two grounding portions, compared with other grounding portions, the grounding portion is located closer to a wire connection point corresponding to the grounding portion.

18. The antenna assembly of claim 16, wherein:
the antenna assembly comprises a transmission interface configured to couple to an external device; and
the transmission interface is electrically connected to and spaced apart from the circuit board, and is grounded through the circuit board to form a parasitic antenna.

19. The antenna assembly of claim 18, wherein:
a minimum distance between the transmission interface and the antenna body is in a range of 0.5 mm to 5 mm.

20. The antenna assembly of claim 18, wherein:
at least one of an inductor, a capacitor, or a resistor is disposed between the transmission interface and the circuit board.

21. An earphone, comprising:
an earphone body; and
an antenna assembly disposed on the earphone body, the antenna assembly including a circuit board and an antenna, wherein:
the antenna includes an antenna body, a feeding portion connected to the antenna body, and at least two grounding portions spaced apart and connected to the antenna body, the at least two grounding portions are spaced apart from the feeding portion, the feeding portion and the at least two grounding portions are connected to the circuit board, and the antenna body is spaced apart from the circuit board.

22. The antenna assembly of claim 16, wherein:
the antenna body forms an operating path between two adjacent grounding portions in the at least two grounding portions, the operating path includes a first operating path, and a length of the first operating path matches a first operating wavelength of the antenna.

23. The antenna assembly of claim 22, wherein:
the antenna body is arranged in a linear form, and a length of the operating path between the two adjacent grounding portions is set as a path length along the antenna body between the two adjacent grounding portions.

24. The antenna assembly of claim 22, wherein:
the antenna body is arranged in a planar form, and the at least two grounding portions are spaced apart on a peripheral edge of the antenna body; and
a length of the operating path between the two adjacent grounding portions is set as a path length along the peripheral edge of the antenna body between the two adjacent grounding portions.

25. The antenna assembly of claim 24, wherein:
the feeding portion and the at least two grounding portions extend from the antenna body and are arranged in a sheet form;
the peripheral edge of the antenna body is provided with a notch, and the feeding portion is connected to an edge of the notch;
one of the at least two grounding portions is connected to an adjacent edge of the peripheral edge, the adjacent edge being connected to the edge of the notch; and
a main surface of the feeding portion and a main surface of the grounding portion connected to the adjacent edge face outward on a same side of the antenna body or are parallel to each other.

26. The antenna assembly of claim 22, wherein:
the antenna body is configured as an integrated structure, and the length of the first operating path is set to an integer multiple of half of the first operating wavelength of the antenna.

27. The antenna assembly of claim 22, wherein:
the antenna body is arranged in a planar form;
a count of the at least two grounding portions is two, and the two grounding portions are connected to a peripheral edge of the antenna body;
the operating path includes a second operating path;
one side edge of the peripheral edge of the antenna body located between the two grounding portions is configured to form the first operating path; and
another side edge of the peripheral edge of the antenna body located between the two grounding portions is configured to form the second operating path.

28. The antenna assembly of claim 27, wherein:
an absolute value of a difference between the length of the first operating path and a length of the second operating path falls within a range of 0 mm to 5 mm.

29. The antenna assembly of claim 27, wherein:
a length of the second operating path is set to match a second operating wavelength of the antenna body different from the first operating wavelength.

30. The antenna assembly of claim 29, wherein:
the first operating wavelength includes a wavelength corresponding to 2.4 GHz, and the second operating wavelength includes a wavelength corresponding to 5 GHz.

31. The antenna assembly of claim 16, wherein:
the antenna body has an electric field strong point location, and includes a first main body portion and a second main body portion divided by the electric field strong point location;
the feeding portion and at least one of the at least two grounding portions are connected to the first main body portion; and
at least one of the remaining of the at least two grounding portions is connected to the second main body portion.

32. The antenna assembly of claim 31, wherein:
the first main body portion and the second main body portion are arranged spaced apart;
the first main body portion has a first gap edge, and the second main body portion has a second gap edge;
the first gap edge and the second gap edge are opposite to and spaced apart from each other to form a gap, the gap separating the first main body portion from the second main body portion;
the first main body portion, the at least one grounding portion connected to the first main body portion, and the feeding portion form a main antenna; and
the second main body portion and the at least one grounding portion connected to the second main body portion form a parasitic antenna.

33. The antenna assembly of claim 32, wherein:
the first main body portion is provided with a first sub-operating path between the first gap edge and the grounding portion connected to the first main body portion, a length of the first sub-operating path being set to an odd multiple of a quarter of a first operating wavelength of the antenna; and/or
the second main body portion is provided with a second sub-operating path between the second gap edge and the grounding portion connected to the second main body portion, a length of the second sub-operating path being set to an odd multiple of the quarter of the first operating wavelength of the antenna.

34. The antenna assembly of claim 32, wherein:
a width of the gap is in a range of 0.1 mm to 5 mm.

35. The antenna assembly of claim 31, wherein:
the first main body portion and the second main body portion are integrally formed.
